(19) United States
(12) Patent Application Publication
(10) Pub. No.: US 2014/0259872 A1
(43) Pub. Date: Sep. 18, 2014

(54) FISH ATTRACTOR

(71) Applicant: Martin Wayne Katilius, Carterville, IL (US)

(72) Inventor: Martin Wayne Katilius, Carterville, IL (US)

(21) Appl. No.: 13/834,468

(22) Filed: Mar. 15, 2013

(51) Int. Cl. A01K 97/02; A01K 85/01

(52) U.S. Cl. CPC A01K 97/02; A01K 85/01
USPC 43/44.99

(57) ABSTRACT

The present invention is generally directed toward a fish attractor. The fish attractor has a cylindrical container having an open end, a closed end and a sidewall therebetween. The sidewall has a plurality of holes therein. A hanger cap plug is removably secured to the open end of the cylindrical container. A dispensing sponge located within the cylindrical container. The dispensing sponge has a scented compound applied thereto. When placed in water, the scent compound passed through the holes in the sidewall of the cylindrical container and released into the water, thereby attracting fish.

### BACKGROUND OF THE INVENTION

As it has been determined through research studies that fish have a sense of smell and can be attracted to certain scents. This can create an advantage to increase the potential for catching more fish by fishermen. To do this effectively, the scent needs to be disbursed underneath the surface of the water via an attractor device at the depths fish are found to be suspended. As such, a device is needed to carry, hold, and disburse the scent accordingly.

### SUMMARY OF THE INVENTION

The present invention satisfies the needs discussed above. The present invention is generally directed toward a fish attractor device for fishermen to apply various scent formulas to and suspend the fish attractor to various depths within the lake, pond, river or stream.

One aspect of the inventive fish attractor includes a cylindrical container, hanger cap plug and a dispensing sponge. Cylindrical container has an open end, a closed end and a sidewall therebetween. The inside diameter of the cylindrical container can vary but normally can range between 0.5 inches to 10 inches in diameter. Further, the inside length of the cylindrical container can vary but normally can range between 1 inch to 24 inches in length. Still further, the sidewall thickness of the cylindrical container can vary but normally can range between 0.010 inches to 0.25 inches in diameter. Furthermore, sidewall has a plurality of holes whose numbers and alignment can vary but normally has four rows of four equally spaced holes.

Hanger cap plug is removably secured to the open end of the cylindrical container. Dispensing sponge is removably located within the interior the cylindrical container. A scent compound is applied to the dispensing sponge. The dimensions of the dispensing sponge are sufficient to allow rotation while located within the cylindrical container.

Upon reading the included description, various alternative embodiments will become obvious to those skilled in the art. These embodiments are to be considered within the scope and spirit of the subject invention, which is only limited by the claims which follow and their equivalents.

### BRIEF DESCRIPTION OF THE DRAWINGS

FIG. 1 is a side view of an embodiment of the fish attractor cylinder, cap, and dispensing sponge of the present invention.

FIG. 2 is a side view of an embodiment of the fish attractor cylinder of the present invention.

FIG. 3 is a side view of an embodiment of the dispensing sponge of the present invention.

FIG. 4 is a side view of an embodiment of the dispersing sponge of the present invention.

### DESCRIPTION OF THE PREFERRED EMBODIMENTS

The present invention satisfies the needs discussed above. The present invention is generally directed toward a fish attractor device for fishermen to apply various scent formulas to and suspend the fish attractor to various depths within the lake, pond, river or stream.

As illustrated in FIG. 1, an embodiment of the inventive fish attractor is disclosed. Examining the invention in more detail, FIG. 1 shows the assembly of the three components of the fish attractor, the hanger cap plug 1, the closed end cylinder container 2, and the dispensing sponge 3. FIG. 1 also depicts how the fish attractor attaches to a floating buoy marker.

In further detail, FIG. 2 shows the specifics of an embodiment of the closed end dispensing cylinder 2. The nominal inside diameter 4 of the cylinder is 3.085 inches but can be varied from 0.5 inches to 10 inches in diameter. The nominal inside length 5 of the cylinder is 6 inches but can be varied from 1 inch to 24 inches in length. The wall thickness 6 is a nominal 0.025 inches but can be varied from 0.010 inches to 0.25 inches while the nominal shape is cylindrical it can vary to square, rectangular, spherical, triangular, octagonal, and hexagonal. The material used in forming the nominal cylinder 6 is clear plastic but material can be varied to colored plastic compounds, polymer compounds, or any metals.

Further illustrated, cylinder 6 has a plurality of holes 7. As illustrated in FIG. 2, cylinder 6 has four rows of four spaced holes 7. These holes are equally spaced around cylinder 6. The use and placement of the holes 7 in FIG. 2 is merely illustrated and can be varied in shape and in number from 2 to 100 holes. The nominal hole diameter 8 on a 6 inch length cylinder is 0.75 inches but may vary from 0.125 inches to 3 inches. The nominal spacing 9 between holes 7 on a 6 inch length cylinder is 0.5 inches but may vary from 0.125 inches to 4 inches. The nominal bottom of the cylinder 10 has an enclosed, sealed bottom which may also be enclosed by a cap or plug.

FIG. 3 shows the internal dispensing sponge component 14. The nominal depth 11 of the sponge 14 is 5 inches but can vary from 1 inch to 24 inches. The nominal length 12 and width 13 is 2 inches respectively but may also vary from 0.5 inches to 8 inches. These dimensions of sponge 14 are illustrative and can be varied in order to conform to the dimensions of cylinder 6. The nominal sponge material 14 is an open-celled synthetic polymer, but may also be varied to use natural sponge.

FIG. 4 depicts the hanger cap plug 1 used in sealing the sponge inside the cylinder and the means by which the fish attractor is attached to the floating buoy line. The nominal material 15 used for making the cap is a colored molded plastic but other materials may be used such as rubber, any metal, or other polymer compounds. The outside diameter of the plug 16 which snuggly slides into the open end of the cylinder is 3 inches. The nominal depth of the plug 17 is 0.688 inches but may vary from 0.25 inches to 2 inches. The top of the plug has a loop attached 19 with a nominal diameter 18 of 0.375 inches which vary from 0.25 inches to 2 inches. These dimensions of hanger cap plug 1 are illustrative and can be varied in order to conform to the dimensions of cylinder 6.

In further detail, the operational aspect of the fish attractor begins with applying some chosen form of liquid, spray or paste to the dispensing sponge 14. The dispensing sponge 14 is then inserted into the closed end attractor cylinder 6. The top hanger plug 1 is inserted snuggly into the open top of the attractor cylinder 6. At this point, the fish attractor is assembled and is ready to be attached to line of a floating buoy and placed into the water to be suspended at a predetermined depth. As water current hits the fish attractor cylinder 6, the dispensing sponge 14 to slowly rotate while dispensing scent into the water through the holes 7 in the side of the attractor cylinder 6.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

We claim:

1. A fish attractor comprising:
a cylindrical container having an open end, a closed end and a sidewall therebetween, the sidewall having plurality of holes therein;
a hanger cap plug removably secured to the open end of the cylindrical container; and
a dispensing sponge located within the cylindrical container, the dispensing sponge having a scented compound applied thereto.

2. The fish attractor of claim 1, wherein the closed end cylinder has as inside diameter of between 0.5 inches to 10 inches in diameter.

3. The fish attractor of claim 1, wherein the closed end cylinder has an inside length of between 1 inch to 24 inches in length.

4. The fish attractor of claim 1, wherein the closed end cylinder has a sidewall thickness of between 0.010 inches to 0.25 inches in diameter.

5. The fish attractor of claim 1, wherein the closed end cylinder has an outer shape selected from the group consisting of square, rectangular, spherical, triangular, octagonal, and hexagonal.

6. The fish attractor of claim 1, wherein the closed end cylinder can be formed from the group consisting of clear plastic, colored plastic compounds, polymer compounds, and any metal.

7. The fish attractor of claim 1, wherein the sidewall of the closed end cylinder has four rows of four equally spaced holes.

8. The fish attractor of claim 1, wherein the dispensing sponge is formed from an open-celled synthetic polymer.

9. The fish attractor of claim 1, wherein the dispensing sponge is formed from a natural sponge.

10. The fish attractor of claim 1, wherein the hanger cap plug further comprises a loop attached to the top portion of hanger cap plug.

11. The fish attractor of claim 1, wherein the scented compound can be in the form selected from the group consisting of liquid, spray or paste.

12. The fish attractor of claim 1, wherein the dispensing sponge has a dimension to allow rotation while located within the cylindrical container.

13. A fish attractor comprising:
a cylindrical container having an open end, a closed end and a sidewall therebetween, wherein the cylinder container has as inside diameter of between 0.5 inches to 10 inches in diameter, an inside length of between 1 inch to 24 inches in length and a sidewall thickness of between 0.010 inches to 0.25 inches in diameter, wherein the sidewall has four rows of four equally spaced holes; a hanger cap plug removably secured to the open end of the cylindrical container; and a dispensing sponge located within the cylindrical container, the dispensing sponge having a scented compound applied thereto, wherein the dispensing sponge has a dimension to allow rotation while located within the cylindrical container.

14. The fish attractor of claim 1, wherein the closed end cylinder has an outer shape selected from the group consisting of square, rectangular, spherical, triangular, octagonal, and hexagonal.

15. The fish attractor of claim 1, wherein the closed end cylinder can be formed from the group consisting of clear plastic, colored plastic compounds, polymer compounds, and any metal.

16. The fish attractor of claim 1, wherein the dispensing sponge is formed from an open-celled synthetic polymer.

17. The fish attractor of claim 1, wherein the dispensing sponge is formed from a natural sponge.

18. The fish attractor of claim 1, wherein the hanger cap plug further comprises a loop attached to the top portion of hanger cap plug.

19. The fish attractor of claim 1, wherein the scented compound can be in the form selected from the group consisting of liquid, spray or paste.
